(19) United States
(12) Patent Application Publication
(10) Pub. No.: US 2026/0053162 A1
(43) Pub. Date: Feb. 26, 2026

(54) TEA POWDER COMPOSITION

(71) Applicant: SUNTORY HOLDINGS LIMITED, Osaka-shi, Osaka (JP)

(72) Inventors: Keita Yoshiwara, Kanagawa (JP); Taishu Hamaba, Kanagawa (JP)

(73) Assignee: SUNTORY HOLDINGS LIMITED, Osaka-shi, Osaka (JP)

(21) Appl. No.: 19/099,568

(22) PCT Filed: Aug. 1, 2023
(86) PCT No.: PCT/JP2023/028045

§ 371 Date: Jan. 29, 2025

(30) Foreign Application Priority Data
Aug. 3, 2022 (JP) 2022-123706

(51) Int. Cl. A23F 3/14

(52) U.S. Cl. CPC A23F 3/14

(57) ABSTRACT

The tea powder composition includes one or more of: solid particle A having a particle diameter larger than 4 mm and equal to or less than 5.6 mm and a thickness of 4 mm or less; solid particle B having a particle diameter larger than 2.8 mm and equal to or less than 4 mm and a thickness of 2.8 mm or less; solid particle C having a particle diameter larger than 2 mm and equal to or less than 2.8 mm and a thickness of 2 mm or less; solid particle D having a particle diameter larger than 1.4 mm and equal to or less than 2 mm and a thickness of 1.4 mm or less; and solid particle E having a particle diameter larger than 1 mm and equal to or less than 1.4 mm and a thickness of 1 mm or less.

### TECHNICAL FIELD

The present invention relates to a tea powder composition and more specifically relates to a tea powder composition that provides a palatable taste when the tea powder composition is dissolved in an aqueous medium such as water or hot water and consumed.

### BACKGROUND ART

Many methods for producing instant powdered beverages obtained by drying various beverages have been developed heretofore. Among them, representative methods are a spray drying method (spray drying) and a vacuum freeze drying method (freeze drying).

The spray drying method is a granulation method of evaporating moisture by applying heat to sprayed droplets. A problem with the spray drying method is that since a heat load is applied to a liquid during drying, components are altered due to heat, or an aroma with a low boiling point is volatilized. On the other hand, since a vacuum device is not used for the spray drying method, initial costs for manufacturing equipment can be kept low, and the spray drying method has an advantage that mass production is facilitated because a vacuum condition is not required. Due to the characteristics thereof, the spray drying method is often used for powdering tea beverages represented by green tea, as tea beverages have features in which product values are not significantly impaired by an aroma with a low boiling point, and tea beverages are suitable for mass production and mass consumption.

On the other hand, the freeze drying method is a method of drying a frozen liquid under a vacuum condition, in which moisture is volatilized at a relatively low temperature. Therefore, the freeze drying method is less likely to alter components due to heat and volatilize an aroma component with a low boiling point, and thus is often used in pulverization of a beverage in which importance is placed on an aroma such as coffee. Meanwhile, since a vacuum device is used in the freeze drying method, there is a burden of initial costs for manufacturing equipment, and there is a disadvantage with, for example, running costs such as energy usage.

While there are the above-described two representative methods of producing instant powdered beverages, the shapes of the “powder” obtained by these methods greatly differ. Due to the differences in shape, the impression, flavor, usability, and the like of the instant powdered beverages during consumption greatly vary.

For example, powder obtained by the spray drying method has a very small particle diameter of about several tens of micrometers through drying via a droplet state. In this case, the following problem arises: the powder scatters or flutters during use, and when the powder is dissolved in water or hot water, droplets clump together to form lumps, a state of floating or sedimentation is caused thereby, an unpleasant mouthfeel is provided, and the powder is difficult to dissolve. On the other hand, since the particle size is very small, there is also an advantage that a flavor can be added without impairing texture of confectionery by sprinkling the powder on the confectionery having smooth texture such as cake.

On the other hand, since powder obtained by the freeze drying method is produced by pulverizing a frozen block, the particle diameter thereof is large as several millimeters, and problems such as scattering and fluttering during use do not arise. In addition, since the obtained powder has a porous structure, the powder is easily dissolved in water of hot water, and lumps and sedimentation are less likely to be generated. Then, since the powder is easily dissolved in water of hot water, the problem of an unpleasant mouthfeel due to undissolved powder does not arise. However, since the particle size of the powder is large, the powder is not suitable for an application as a topping to be sprinkled on confectionery having smooth texture and provides unwanted texture such as coarse texture.

As a conventional technique related to instant powdered beverages, instant powdered tea which contains tea polyphenol at a high concentration and which is excellent in the original flavor of tea and mouthfeel has been reported (PTL 1), for example. In addition, pulverized tea in which surfaces of pulverized tea leaves are coated with an extraction liquid from other tea leaves and which has enhanced solubility and provides the original flavor of tea leaves (PTL 2) is also exemplified as one of conventional techniques.

### CITATION LIST

### Patent Literature

PTL 1: Japanese Patent Laid-Open No. 2008-306980

PTL 2: Japanese Patent Laid-Open No. 2014-97023

### SUMMARY OF INVENTION

### Technical Problem

As described above, in the technical field of tea beverages, improving the original aroma and taste of tea is one object in developing and designing an instant powdered beverage. Therefore, an object of the present invention is to provide a tea powder composition which provides a preferable sensation when the tea powder composition is dissolved in an aqueous medium such as water or hot water and consumed.

### Solution to Problem

As a result of intensive studies to solve the above problem, the present inventors have found that an instant powdered tea beverage which provides a preferable sensation when the instant powdered tea beverage is consumed can be obtained by focusing attention on the shape of powder particles and adjusting the shape to a shape specified by a predetermined particle diameter and thickness. Based on such findings, the present inventors have completed the present invention.

That is, the present invention relates to the following aspects but is not limited thereto.
(1) A tea powder composition including one or more of (a) to (e) below:
(a) solid particle A having a particle diameter larger than 4 mm and equal to or less than 5.6 mm and a thickness of 4 mm or less;
(b) solid particle B having a particle diameter larger than 2.8 mm and equal to or less than 4 mm and a thickness of 2.8 mm or less;
(c) solid particle C having a particle diameter larger than 2 mm and equal to or less than 2.8 mm and a thickness of 2 mm or less;
(d) solid particle D having a particle diameter larger than 1.4 mm and equal to or less than 2 mm and a thickness of 1.4 mm or less; and
(e) solid particle E having a particle diameter larger than 1 mm and equal to or less than 1.4 mm and a thickness of 1 mm or less, in which the total content of solid particles A to E is 10% by weight or more, and the content of solid particles having a particle diameter exceeding 5.6 mm is 15% by weight or less.
(2) The composition according to (1), in which the total content of solid particles A to E is 20% by weight or more.
(3) The composition according to (1) or (2), in which the content of the solid particles having a particle diameter exceeding 5.6 mm is 8% by weight or less.
(4) The composition according to any one of (1) to (3), in which solid particles A to E have a shape of pulverized tea leaves.
(5) The composition according to any one of (1) to (4), in which the composition is packaged in a container.
(6) The composition according to (5), in which the container is a transparent container.

### Advantageous Effects of Invention

According to the present invention, a tea powder composition which provides a preferable sensation when the tea powder composition is dissolved in an aqueous medium such as water or hot water and consumed can be provided. In addition, by utilizing the technique of the present invention, it is possible to provide a tea powder composition which is excellent in relation to ease of dissolving in the mouth when the tea powder composition is directly taken, coarse texture when the tea powder composition is chewed, and ease of swallowing. The tea powder composition of the present invention can be produced by utilizing a freeze drying method, whereby alteration of components due to heat and volatilization of an aroma component with a low boiling point can be suppressed. In addition, it is also possible to provide a tea powder composition which is easily dissolved in water or hot water by utilizing a freeze drying method.

### BRIEF DESCRIPTION OF DRAWINGS

FIG. 1 is a diagram illustrating a device for examining the thickness of solid particles included in a tea powder composition.

FIG. 2 is graphs showing results of examining alpha wave asymmetry after consuming each sample.

### DESCRIPTION OF EMBODIMENTS

The tea powder composition of the present invention will be described below. Unless otherwise described, “ppm,” “ppb,” and “% by weight” as used herein refer to ppm, ppb, and % by weight in terms of weight/weight (w/w), respectively.

One aspect of the present invention is a tea powder composition comprising one or more of (a) to (e) below:
(a) solid particle A having a particle diameter larger than 4 mm and equal to or less than 5.6 mm and a thickness of 4 mm or less;
(b) solid particle B having a particle diameter larger than 2.8 mm and equal to or less than 4 mm and a thickness of 2.8 mm or less;
(c) solid particle C having a particle diameter larger than 2 mm and equal to or less than 2.8 mm and a thickness of 2 mm or less;
(d) solid particle D having a particle diameter larger than 1.4 mm and equal to or less than 2 mm and a thickness of 1.4 mm or less; and
(e) solid particle E having a particle diameter larger than 1 mm and equal to or less than 1.4 mm and a thickness of 1 mm or less, wherein the total content of solid particles A to E is 10% by weight or more, and the content of solid particles having a particle diameter exceeding 5.6 mm is 15% by weight or less. By adopting such a configuration, a preferable sensation can be provided when a tea beverage is prepared by dissolving the tea powder composition in a liquid such as water or hot water, and the tea beverage is consumed. Here, in the present description, “providing a preferable sensation when a tea beverage is consumed” means that a favorable impression that makes one feel inclined to approach the tea beverage in question is given.

The tea powder composition of the present invention can be produced using a tea leaf pulverized product or a tea leaf extract. Therefore, the tea powder composition of the present invention can contain the tea leaf pulverized product or the tea leaf extract. Here, in the present description, the “tea leaf pulverized product” means a product obtained by pulverizing tea leaves, and the “tea leaf extract” means a component extracted from tea leaves. The tea leaf extract can be obtained from a tea leaf extraction liquid. In the present invention, as the tea leaves, leaves obtained from a plant of the genus Camellia in the family Theaceae (Camellia sinensis (L) O. Kuntze or the like) can be used. The tea leaves used in the present invention can be classified into non-fermented tea, semi-fermented tea, and fermented tea according to processing methods. Examples of the non-fermented tea include green tea such as Aracha, Sencha, Gyokuro, Kabusecha, Tencha, Bancha, Hojicha, Kamairicha, Kukicha, Boucha, and Mecha. Examples of the semi-fermented tea include oolong tea such as Tieguanyin, Sezhong, Huangjin Gui, and Wuyi Yancha. Examples of the fermented tea include black tea such as Darjeeling, Assam, and Ceylon. In the present invention, tea leaves may be used alone, or in a blend of a plurality of kinds of tea leaves. The tea leaves are not particularly limited as long as the tea leaves are a site from which an aromatic component can be extracted, and a leaf, a stem, or the like can be appropriately used, and the form thereof is also not limited and includes a large leaf, a powdery form, and the like.

The particle shape and size of the tea leaf pulverized product are not particularly limited, but a tea leaf pulverized product having a particle size of about 1 to 100 μm and preferably about 1 to 50 μm in terms of average particle diameter is preferably used. In the present invention, although not particularly limited, a tea leaf pulverized product of green tea is preferably used, and Matcha is more preferably used. The tea leaf extract is not particularly limited, but a tea leaf extract of green tea is used, and a tea leaf extract of Sencha is more preferably used. Although not particularly limited, the tea powder composition of the present invention preferably contains a tea leaf pulverized product or a tea leaf extract of green tea. The tea powder composition of the present invention more preferably contains Matcha or a tea leaf extract of Sencha.

The content of the tea leaf pulverized product or the tea leaf extract in the tea powder composition of the present invention is not particularly limited, and can be appropriately adjusted. The content of the tea leaf pulverized product or the tea leaf extract is, for example, 5% to 95% by weight, 20% to 80% by weight, 30% to 70% by weight, or 40% to 60% by weight.

The tea powder composition of the present invention contains any one or more of solid particles A to E specified by various particle diameters and thicknesses. In the present description, the particle diameter of a solid particle corresponds to a length of a short side of a face (a length of one side when the face is a square) having the maximum area of a rectangular parallelepiped covering the solid particle so as to be inscribed in all six faces. The particle diameter of the solid particles can be examined using various sieves described in Japanese Industrial Standards JIS Z8815-1994, and whether the particle diameter is larger or smaller than the opening of the sieve can be confirmed from the numerical value (size) of the opening of the sieve. For example, when the solid particles pass through a sieve, it can be determined that the particle diameter of the solid particles is smaller than the numerical value (size) of the opening of the sieve used.

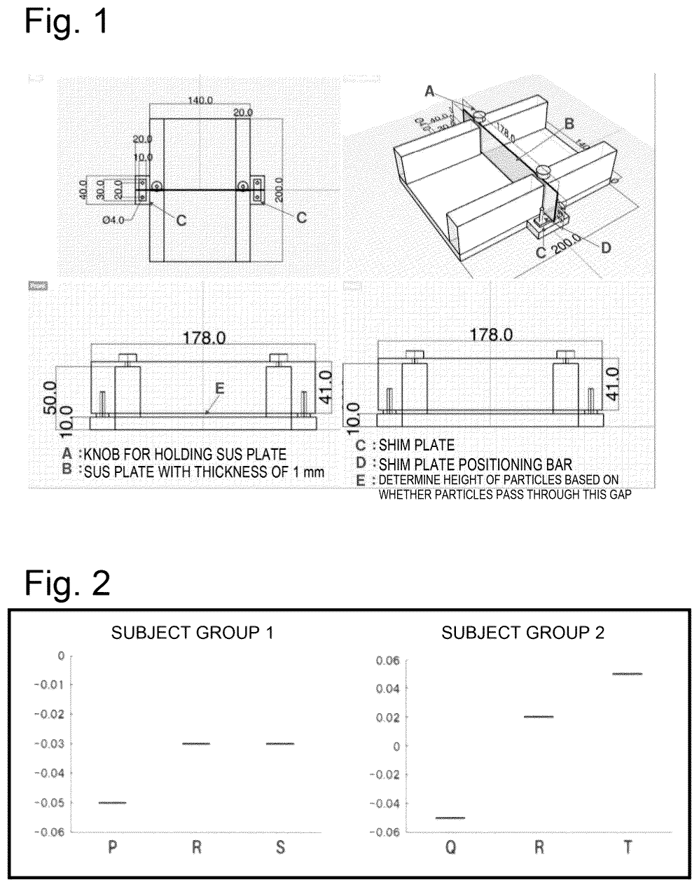

In addition, in the present description, the thickness of a solid particle corresponds to a length of a short side of a face (a length of one side when the face is a square) having the minimum area of a rectangular parallelepiped covering the solid particle so as to be inscribed in all six faces. The thickness of the solid particles can be examined using a device having a space (gap) with a predetermined size, and whether the thickness is larger or smaller than the size of the space (gap) can be confirmed from the size of the space (gap). For example, a device illustrated in FIG. 1 is used, and when the solid particles pass through a space (gap) provided in the device, it can be determined that the thickness of the solid particles is smaller than the size of the space (gap).

Solid particle A has a particle diameter larger than 4 mm and equal to or less than 5.6 mm and a thickness of 4 mm or less. Solid particle A can be classified into solid particles A1 to A8 according to the thickness as follows.
(a1) Solid particle A1 having a particle diameter larger than 4 mm and equal to or less than 5.6 mm and a thickness larger than 2.8 mm and equal to or less than 4 mm.
(a2) Solid particle A2 having a particle diameter larger than 4 mm and equal to or less than 5.6 mm and a thickness larger than 2 mm and equal to or less than 2.8 mm.
(a3) Solid particle A3 having a particle diameter larger than 4 mm and equal to or less than 5.6 mm and a thickness larger than 1.4 mm and equal to or less than 2 mm.
(a4) Solid particle A4 having a particle diameter larger than 4 mm and equal to or less than 5.6 mm and a thickness larger than 1 mm and equal to or less than 1.4 mm.
(a5) Solid particle A5 having a particle diameter larger than 4 mm and equal to or less than 5.6 mm and a thickness larger than 0.7 mm and equal to or less than 1 mm.
(a6) Solid particle A6 having a particle diameter larger than 4 mm and equal to or less than 5.6 mm and a thickness larger than 0.5 mm and equal to or less than 0.7 mm.
(a7) Solid particle A7 having a particle diameter larger than 4 mm and equal to or less than 5.6 mm and a thickness larger than 0.35 mm and equal to or less than 0.5 mm.
(a8) Solid particle A8 having a particle diameter larger than 4 mm and equal to or less than 5.6 mm and a thickness of 0.35 mm or less.

The tea powder composition of the present invention can include any one or more of solid particles A1 to A8, preferably any two or more of solid particles A1 to A8, more preferably any three or more of solid particles A1 to A8, and still more preferably any four or more of solid particles A1 to A8. In the present invention, among solid particles A1 to A8, any one or more of solid particles A2 to A8 are preferably included, any one or more of solid particles A3 to A8 are more preferably included, and any one or more (or two or more, three or more, four or more, five or more, or all) of solid particles A3 to A7 are still more preferably included.

The ratio (Z/X) of the thickness (Z) to the particle diameter (X) of solid particle A is not particularly limited, but is, for example, less than 1, preferably 0.80 or less, more preferably 0.71 or less, still more preferably 0.60 or less, and even more preferably 0.50 or less. The ratio (Z/X) is not particularly limited, but is, for example, 0.01 or more, preferably 0.03 or more, more preferably 0.05 or more, and still more preferably 0.10 or more. The ratio (Z/X) is not particularly limited, but is, for example, 0.01 or more and less than 1, preferably 0.03 to 0.80, more preferably 0.05 to 0.71, and still more preferably 0.10 to 0.50.

Solid particle B has a particle diameter larger than 2.8 mm and equal to or less than 4 mm and a thickness of 2.8 mm or less. Solid particle B can be classified into solid particles B1 to B7 according to the thickness as follows.
(b1) Solid particle B1 having a particle diameter larger than 2.8 mm and equal to or less than 4 mm and a thickness larger than 2 mm and equal to or less than 2.8 mm.
(b2) Solid particle B2 having a particle diameter larger than 2.8 mm and equal to or less than 4 mm and a thickness larger than 1.4 mm and equal to or less than 2 mm.
(b3) Solid particle B3 having a particle diameter larger than 2.8 mm and equal to or less than 4 mm and a thickness larger than 1 mm and equal to or less than 1.4 mm.
(b4) Solid particle B4 having a particle diameter larger than 2.8 mm and equal to or less than 4 mm and a thickness larger than 0.7 mm and equal to or less than 1 mm.
(b5) Solid particle B5 having a particle diameter larger than 2.8 mm and equal to or less than 4 mm and a thickness larger than 0.5 mm and equal to or less than 0.7 mm.
(b6) Solid particle B6 having a particle diameter larger than 2.8 mm and equal to or less than 4 mm and a thickness larger than 0.35 mm and equal to or less than 0.5 mm.
(b7) Solid particle B7 having a particle diameter larger than 2.8 mm and equal to or less than 4 mm and a thickness of 0.35 mm or less.

The tea powder composition of the present invention can include any one or more of solid particles B1 to B7, preferably any two or more of solid particles B1 to B7, more preferably any three or more of solid particles B1 to B7, and still more preferably any four or more of solid particles B1 to B7. In the present invention, among solid particles B1 to B7, any one or more of solid particles B2 to B7 are preferably included, and any one or more (or two or more, three or more, four or more, or all) of solid particles B2 to B6 are more preferably included.

The ratio (Z/X) of the thickness (Z) to the particle diameter (X) of solid particle B is not particularly limited, but is, for example, less than 1, preferably 0.80 or less, more preferably 0.71 or less, still more preferably 0.60 or less, and even more preferably 0.50 or less. The ratio (Z/X) is not particularly limited, but is, for example, 0.01 or more, preferably 0.03 or more, more preferably 0.05 or more, and still more preferably 0.10 or more. The ratio (Z/X) is not particularly limited, but is, for example, 0.01 or more and less than 1, preferably 0.03 to 0.80, more preferably 0.05 to 0.71, and still more preferably 0.10 to 0.50.

Solid particle C has a particle diameter larger than 2 mm and equal to or less than 2.8 mm and a thickness of 2 mm or less. Solid particle C can be classified into solid particles C1 to C6 according to the thickness as follows.
(c1) Solid particle C1 having a particle diameter larger than 2 mm and equal to or less than 2.8 mm and a thickness larger than 1.4 mm and equal to or less than 2 mm.
(c2) Solid particle C2 having a particle diameter larger than 2 mm and equal to or less than 2.8 mm and a thickness larger than 1 mm and equal to or less than 1.4 mm.
(c3) Solid particle C3 having a particle diameter larger than 2 mm and equal to or less than 2.8 mm and a thickness larger than 0.7 mm and equal to or less than 1 mm.
(c4) Solid particle C4 having a particle diameter larger than 2 mm and equal to or less than 2.8 mm and a thickness larger than 0.5 mm and equal to or less than 0.7 mm.
(c5) Solid particle C5 having a particle diameter larger than 2 mm and equal to or less than 2.8 mm and a thickness larger than 0.35 mm and equal to or less than 0.5 mm.
(c6) Solid particle C6 having a particle diameter larger than 2 mm and equal to or less than 2.8 mm and a thickness of 0.35 mm or less.

The tea powder composition of the present invention can include any one or more of solid particles C1 to C6, preferably any two or more of solid particles C1 to C6, more preferably any three or more of solid particles C1 to C6, and still more preferably any four or more of solid particles C1 to C6. In the present invention, among solid particles C1 to C6, any one or more of solid particles C2 to C6 are preferably included, and any one or more (or two or more, three or more, or all) of solid particles C2 to C5 are more preferably included.

The ratio (Z/X) of the thickness (Z) to the particle diameter (X) of solid particle C is not particularly limited, but is, for example, less than 1, preferably 0.80 or less, more preferably 0.71 or less, still more preferably 0.60 or less, and even more preferably 0.50 or less. The ratio (Z/X) is not particularly limited, but is, for example, 0.01 or more, preferably 0.03 or more, more preferably 0.05 or more, and still more preferably 0.10 or more. The ratio (Z/X) is not particularly limited, but is, for example, 0.01 or more and less than 1, preferably 0.03 to 0.80, more preferably 0.05 to 0.71, and still more preferably 0.10 to 0.50.

Solid particle D has a particle diameter larger than 1.4 mm and equal to or less than 2 mm and a thickness of 1.4 mm or less. Solid particle D can be classified into solid particles D1 to D5 according to the thickness as follows.
(d1) Solid particle D1 having a particle diameter larger than 1.4 mm and equal to or less than 2 mm and a thickness larger than 1 mm and equal to or less than 1.4 mm.
(d2) Solid particle D2 having a particle diameter larger than 1.4 mm and equal to or less than 2 mm and a thickness larger than 0.7 mm and equal to or less than 1 mm.
(d3) Solid particle D3 having a particle diameter larger than 1.4 mm and equal to or less than 2 mm and a thickness larger than 0.5 mm and equal to or less than 0.7 mm.
(d4) Solid particle D4 having a particle diameter larger than 1.4 mm and equal to or less than 2 mm and a thickness larger than 0.35 mm and equal to or less than 0.5 mm.
(d5) Solid particle D5 having a particle diameter larger than 1.4 mm and equal to or less than 2 mm and a thickness of 0.35 mm or less.

The tea powder composition of the present invention can include any one or more of solid particles D1 to D5, preferably any two or more of solid particles D1 to D5, more preferably any three or more of solid particles D1 to D5, and still more preferably any four or more of solid particles D1 to D5. In the present invention, among solid particles D1 to D5, any one or more of solid particles D2 to D5 are preferably included, and any one or more (or two or more or all) of solid particles D2 to D4 are more preferably included.

The ratio (Z/X) of the thickness (Z) to the particle diameter (X) of solid particle D is not particularly limited, but is, for example, less than 1, preferably 0.80 or less, more preferably 0.71 or less, still more preferably 0.60 or less, and even more preferably 0.50 or less. The ratio (Z/X) is not particularly limited, but is, for example, 0.01 or more, preferably 0.03 or more, more preferably 0.05 or more, and still more preferably 0.10 or more. The ratio (Z/X) is not particularly limited, but is, for example, 0.01 or more and less than 1, preferably 0.03 to 0.80, more preferably 0.05 to 0.71, and still more preferably 0.10 to 0.50.

Solid particle E has a particle diameter larger than 1 mm and equal to or less than 1.4 mm and a thickness of 1 mm or less. Solid particle E can be classified into solid particles E1 to E4 according to the thickness as follows.
(e1) Solid particle E1 having a particle diameter larger than 1 mm and equal to or less than 1.4 mm and a thickness larger than 0.7 mm and equal to or less than 1 mm.
(e2) Solid particle E2 having a particle diameter larger than 1 mm and equal to or less than 1.4 mm and a thickness larger than 0.5 mm and equal to or less than 0.7 mm.
(e3) Solid particle E3 having a particle diameter larger than 1 mm and equal to or less than 1.4 mm and a thickness larger than 0.35 mm and equal to or less than 0.5 mm.
(e4) Solid particle E4 having a particle diameter larger than 1 mm and equal to or less than 1.4 mm and a thickness of 0.35 mm or less.

The tea powder composition of the present invention can include any one or more of solid particles E1 to E4, preferably any two or more of solid particles E1 to E4, more preferably any three or more of solid particles E1 to E4, and still more preferably all of solid particles E1 to E4. In the present invention, among solid particles E1 to E4, any one of more of solid particles E2 to E4 are preferably included, and any one or more (or both) of solid particles E2 and E3 are more preferably included.

The ratio (Z/X) of the thickness (Z) to the particle diameter (X) of solid particle E is not particularly limited, but is, for example, less than 1, preferably 0.80 or less, more preferably 0.71 or less, still more preferably 0.60 or less, and even more preferably 0.50 or less. The ratio (Z/X) is not particularly limited, but is, for example, 0.01 or more, preferably 0.03 or more, more preferably 0.05 or more, and still more preferably 0.10 or more. The ratio (Z/X) is not particularly limited, but is, for example, 0.01 or more and less than 1, preferably 0.03 to 0.80, more preferably 0.05 to 0.71, and still more preferably 0.10 to 0.50.

The tea powder composition of the present invention can further include solid particle F having a particle diameter larger than 0.71 mm and equal to or less than 1 mm and a thickness of 0.71 mm or less. Solid particle F can be classified into solid particles F1 to F3 according to the thickness as follows.
(f1) Solid particle F1 having a particle diameter larger than 0.71 mm and equal to or less than 1 mm and a thickness larger than 0.5 mm and equal to or less than 0.7 mm.
(f2) Solid particle F2 having a particle diameter larger than 0.71 mm and equal to or less than 1 mm and a thickness larger than 0.35 mm and equal to or less than 0.5 mm.
(f3) Solid particle F3 having a particle diameter larger than 0.71 mm and equal to or less than 1 mm and a thickness of 0.35 mm or less.

The tea powder composition of the present invention can include any one or more of solid particles F1 to F3, preferably any two or more of solid particles F1 to F3, and more preferably all of solid particles F1 to F3.

The ratio (Z/X) of the thickness (Z) to the particle diameter (X) of solid particle F is not particularly limited, but is, for example, less than 1, preferably 0.80 or less, more preferably 0.71 or less, still more preferably 0.60 or less, and even more preferably 0.50 or less. The ratio (Z/X) is not particularly limited, but is, for example, 0.01 or more, preferably 0.03 or more, more preferably 0.05 or more, and still more preferably 0.10 or more. The ratio (Z/X) is not particularly limited, but is, for example, 0.01 or more and less than 1, preferably 0.03 to 0.80, more preferably 0.05 to 0.71, and still more preferably 0.10 to 0.50.

In the present invention, solid particle A (A1 to A8), solid particle B (B1 to B7), solid particle C (C1 to C6), solid particle D (D1 to D5), solid particle E (E1 to E4), and solid particle F (F1 to F3) preferably have a shape of pulverized tea leaves. In the present description, the “shape of pulverized tea leaves” means a thin flat shape, and can also be referred to as a substantially flaky shape or a substantially flat shape. When the tea powder composition of the present invention has such a shape, the tea powder composition of the present invention can provide a visual effect like an aggregate of pulverized tea leaves.

In the tea powder composition of the present invention, the total content of solid particles A to E is 10% by weight or more. When the content falls within the above range, the tea powder composition of the present invention tends to provide a preferable sensation when the tea powder composition is consumed. In the present description, the total content of solid particles A to E means the total content of solid particles A to E included in the tea powder composition, and when only solid particles A, B, and C are included in the tea powder composition, the total content thereof is the total content of solid particles A, B, and C included in the tea powder composition, for example. In the tea powder composition of the present invention, the total content of solid particles A to E is preferably 20% by weight or more, more preferably 30% by weight or more, still more preferably 50% by weight or more, and even more preferably 70% by weight or more. The content is, for example, 100% by weight or less, 95% by weight or less, or 90% by weight or less. In the tea powder composition of the present invention, the total content of solid particles A to E is, for example, 10% to 100% by weight, preferably 10% to 95% by weight, 10% to 90% by weight, 20% to 100% by weight, 20% to 95% by weight, 20% to 90% by weight, 50% to 100% by weight, 50% to 95% by weight, or 50% to 90% by weight.

When the tea powder composition of the present invention includes solid particle F, the content of solid particle F in the tea powder composition of the present invention is not particularly limited, but is, for example, 90% by weight or less, preferably 70% by weight or less, more preferably 50% by weight or less, and still more preferably 30% by weight or less, 20% by weight or less, 10% by weight or less, or 5% by weight or less.

The tea powder composition of the present invention may include a solid particle having a particle diameter exceeding 5.6 mm in addition to solid particles A to F described above. The content of the solid particle having a particle diameter exceeding 5.6 mm in the tea powder composition of the present invention is 15% by weight or less. When the content falls within the above range, the tea powder composition of the present invention tends to provide a preferable sensation when the tea powder composition is consumed. The content of the solid particle having a particle diameter exceeding 5.6 mm in the tea powder composition of the present invention is preferably 12% by weight or less, more preferably 10% by weight or less, still more preferably 8% by weight or less, and even more preferably 5% by weight or less. The content is, for example, 0% by weight or more, 0.1% by weight or more, 0.5% by weight or more, or 1.0% by weight or more. The content of the solid particle having a particle diameter exceeding 5.6 mm in the tea powder composition of the present invention is, for example, 0% to 15% by weight, preferably 0% to 10% by weight, 0% to 5% by weight, 0.1% to 15% by weight, 0.1% to 10% by weight, or 0.1% to 5% by weight.

The tea powder composition of the present invention can include a polysaccharide. In the present description, the “polysaccharide” means a substance in which two or more monosaccharide molecules are polymerized via a glycoside bond. The polysaccharide in the present invention may include a molecule other than monosaccharides in the polymer thereof. In the present invention, the polysaccharide can be used as an excipient for forming the tea powder composition. Examples of the polysaccharide include dextrin. Dextrin is a collective term for hydrocarbons obtained through hydrolysis of starch or glycogen. Dextrins used in the tea powder composition of the present invention are not particularly limited, and one or more, two or more, three or more, or four or more dextrins can be used.

The content of dextrin in the tea powder composition of the present invention is not particularly limited but is, for example, 0% to 95% by weight, preferably 10% to 90% by weight, more preferably 20% to 80% by weight, and still more preferably 30% to 70% by weight as the total content of dextrin. A commercially available product can be used as dextrin in the present invention. The content of dextrin in the tea powder composition can be measured by carrying out sugar analysis using a method known to a person skilled in the art.

Dextrin used in the present invention is not particularly limited but includes a linear dextrin, a cyclic dextrin, and a spiral dextrin. The “linear dextrin” herein means dextrin in which glucose molecules linearly bind to each other or bind to each other in a chain form with a branched chain and which forms neither a cyclic structure nor a spiral structure. The “cyclic dextrin” herein means dextrin in which glucose molecules bind to each other to form a cyclic structure and which does not form a spiral structure. The “spiral dextrin” herein means dextrin in which glucose molecules bind to each other to form a spiral structure.

Although the linear dextrin is not particularly limited, a linear dextrin having a dextrose equivalent (DE) of 1 to 25, a linear dextrin having a weight average molecular weight of 500 to 160000, and the like can be used, for example. In the present invention, linear dextrins may be used singly or also in combination.

Cyclodextrin can be used as the cyclic dextrin, for example. In the present invention, any of α-cyclodextrin, β-cyclodextrin, and γ-cyclodextrin can be used. In the present invention, cyclic dextrins may be used singly or also in combination of two or more. The weight average molecular weight of the cyclic dextrin used in the present invention is not particularly limited, but is, for example, 700 to 1300.

The tea powder composition of the present invention may contain a spiral dextrin. The DE of the spiral dextrin used in the present invention is not particularly limited, but is, for example, less than 7, preferably less than 6, and more preferably less than 5.

In addition to the components described above, additives used in ordinary food products and beverages. for example, an antioxidant, a preservative, a pH adjuster, a sweetener, a nutritional enhancer, a thickening stabilizer, an emulsifier, dietary fibers, a quality stabilizer, and the like can be added to the tea powder composition of the present invention within a range not impairing the effect of the present invention.

The tea powder composition of the present invention can be contained in food products and beverages (drinks and foods). That is, in the present invention, a food product or beverage containing the tea powder composition described above can be provided. The tea powder composition of the present invention is preferably contained in an aqueous medium to provide a beverage, and is most preferably dissolved in water or hot water and consumed as a tea beverage. In this regard, the tea powder composition of the present invention can also be provided as instant powdered tea. Here, in the present description, the “instant powdered tea” means a powdered beverage obtained by drying a solution including, as a raw material, a pulverized product or extraction liquid of tea leaves and processing same into a powdery form. The tea beverage includes non-fermented tea (green tea and the like), semi-fermented tea (oolong tea and the like), and fermented tea (black tea and the like), and specific examples thereof can include tea such as steamed non-fermented tea (green tea) such as Sencha, Bancha, Hojicha, Gyokuro, Kabusecha, and Tencha; non-fermented tea such as Kamairi Tea including Ureshino tea, Aoyagi tea, and various kinds of Chinese tea; semi-fermented tea such as Pouchong tea, Tieguanyin, and oolong tea; and fermented tea such as black tea, Awa Bancha, and pu-erh tea. The tea beverage utilizing the tea powder composition of the present invention is preferably green tea. That is, tea powder composition of the present invention can also be provided as instant powdered green tea.

When the tea powder composition of the present invention is contained in an aqueous solvent such as water or hot water, the content thereof in the solution is not particularly limited, but is, for example, 0.05% to 30% by weight (w/v), preferably 0.1% to 25% by weight (w/v), more preferably 0.2% to 20% by weight (w/v), and still more preferably 0.25% to 15% by weight (w/v).

The tea powder composition of the present invention can also be added to a food product. Examples of such food products include cake, castella, candies, cookies, jelly, pudding, chocolate, and the like as confectionery, ice cream, ice pops, sherbet, and the like as frozen confectionery, and snacks regardless of whether the confectionery is Japanese confectionery or western confectionery. The tea powder composition of the present invention can also be used for bread, dairy products, and the like.

When the tea powder composition of the present invention is added to a food product, the addition amount thereof can be appropriately set according to, for example, the kind of the food product. The tea powder composition of the present invention can be added to a food product such that the content thereof in the food product is, for example, 0.01% to 90% by weight, preferably 0.05% to 50% by weight, more preferably 0.1% to 20% by weight, and still more preferably 0.2% to 10% by weight.

The tea powder composition of the present invention is preferably packaged in a container. The container in which the tea powder composition of the present invention is accommodated may have any shape, and examples thereof include a tea canister-shaped container and a stick-shaped container. A refillable container can also be used. The container in which the tea powder composition of the present invention is accommodated is preferably a transparent container. By using a transparent container, the inside of the container can be easily visually recognized, and the visual effect of the tea powder composition of the present invention can be sufficiently exhibited. Here, in the present description, the term “transparent container” means a container through which contents accommodated in the container can be visually recognized from the outside. The concept of the transparent container also encompasses a case where the contents can be visually recognized from the outside through a part of the container. Examples of the transparent container can include a container having a transparent region in which the transmittance of visible light at 700 nm is 40% or more, preferably 50% or more. Specific examples thereof can include a transparent glass bottle, a transparent plastic bottle, a transparent plastic cup, a transparent pouch container, and a transparent stick container. Although the color of the container is not limited, the container is preferably colorless.

The tea powder composition of the present invention can be produced through, for example, (A) a step of preparing a solution containing a tea leaf pulverized product or a tea leaf extract, (B) a step of drying the solution containing the tea leaf pulverized product or the tea leaf extract, and (C) a step of pulverizing the obtained dried product.

The step (A) of preparing a solution containing a tea leaf pulverized product or a tea leaf extract can be carried out by using the above-described tea leaves as a raw material to obtain a pulverized product thereof (tea leaf pulverized product) or an extraction liquid thereof (tea leaf extraction liquid). Tea leaves can be pulverized by using a method known to a person skilled in the art. Pulverization processing can be carried out by using a pulverization device such as a power mill, a jet mill, or a stone mill, for example. Extraction of tea leaves can be carried out by using a method known to a person skilled in the art. Extraction processing can be carried out by using an extraction device such as a kneader extractor and adding water or hot water at 5 to 50 times the weight of the tea leaves, for example. Extraction conditions can be appropriately set according to the kind of tea leaves used or a tea beverage to be produced. An extraction temperature can be, for example, 10° C. to 100° C. and preferably 40°° C. to 80° C., and an extraction time can be, for example, 1 to 100 minutes and preferably 10 to 60 minutes, but the extraction temperature and the extraction time are not particularly limited thereto. The tea leaves after extraction may be removed by solid-liquid separation using a filter or the like.

The solution containing a tea leaf pulverized product or a tea leaf extract may include a component such as the polysaccharide described above. For example, when dextrin is used as the polysaccharide, stability of a preparation after drying and retention of a flavor derived from tea can be enhanced. When dextrin is used, the content of dextrin in the solution is not particularly limited, but can be. for example, 2% to 30% by weight and preferably 5% to 20% by weight.

The solution containing a tea leaf extract may be a concentrate of a tea leaf extraction liquid. Concentration of the tea leaf extraction liquid can be carried out by a method known to a person skilled in the art and can be carried out by using a device such as a membrane concentrator, a vacuum concentrator, a freeze concentrator, or an evaporative concentrator, for example.

In the step (B) of drying the solution containing the tea leaf pulverized product or the tea leaf extract, the solution can be dried by using a method known to a person skilled in the art. Examples thereof include freeze drying, spray drying, hot air drying, and vacuum drying, and freeze drying is preferably used in the present invention. Freeze drying can be carried out by, for example, a three-step process. The first step is, for example, a freezing step, and although not particularly limited, the freezing step can be carried out, for example, at a temperature of −80°° C. to −30°° C. (preferably −60°° C. to −20°° C.) for 3 to 10 hours (preferably 4 to 8 hours). The second step is, for example, a primary drying step, and although not particularly limited, the pressure is adjusted to 10 to 100 Pa (preferably 20 to 60 Pa), and the primary drying step can be carried out at a temperature of −10°° C. to 20°° C. (preferably −5° C. to 10° C.) for 6 to 15 hours (preferably 8 to 12 hours), for example. The third step is, for example, a secondary drying step, and although not particularly limited, the pressure is adjusted to 10 to 100 Pa (preferably 20 to 60 Pa), and the secondary drying step can be carried out at a temperature of 20° C. to 60° C. (preferably 30°° C. to 50°° C.) for 5 to 15 hours (preferably 6 to 12 hours), for example. In the present invention, a shelf-type freeze dryer is preferably used from the viewpoint of the subsequent pulverization processing of the dried product. The tea powder composition of the present invention can be a composition having a porous structure through a freeze drying step during production.

In the step (C) of pulverizing the obtained dried product, the dried product of the solution formed in the step (B) is pulverized in order to obtain the solid particles described above. The dried product can be pulverized by using a commercially available pulverization machine such as a power mill, a ball mill, a jet mill, or a roll granulator. Condition for pulverizing the dried product can be appropriately set according to the pulverization machine used.

The pulverized product obtained in the step (C) can be sorted in terms of the shape of each solid particle by using, for example, the above-described sieve or the device shown in FIG. 1. Sorting of solid particles can be carried out also by visual observation not only by the above-described sieve or the device shown in FIG. 1. The solid particles finally obtained through sorting can be accommodated in a container if needed, and a tea powder composition packaged in a container can be thus produced.

### EXAMPLES

Hereinafter, the present invention will be specifically described in detail by showing examples, but the present invention is not limited thereto. The numerical ranges described herein include the endpoints thereof unless otherwise stated.

Matcha, dextrin (Sandec #30, manufactured by Sanwa Starch Co., Ltd.), and L-ascorbic acid were added to water to prepare a preparation liquid having a solid content concentration of 20% by weight (Matcha: 9.5% by weight, dextrin: 9.5% by weight, L-ascorbic acid: 1.0% by weight).

The prepared preparation liquid was poured into a tray, and the tray was placed in a shelf-type freeze dryer (RL-BC07. manufactured by NISSEI Co., Ltd.) to carry out a freeze drying processing. Conditions of freeze drying were as follows: freezing at −40° C. for about 6 hours, then reducing the pressure to 40 Pa, leaving to stand at 0°° C. for 10 hours, and then leaving to stand at 40° C. for 8 hours while maintaining the pressure at 40 Pa.

After the freeze drying, the sample was taken out from the tray and pulverized using a power mill (P-3, DALTON Corporation). The rotation speed of the power mill was set to 2000 rpm, and herringbone #8 was used as the screen.

The pulverized sample was subjected to a sieving test using a sieve described in Japanese Industrial Standard JIS Z8815-1994, Test Sieving-General Requirements. The sieve opening sizes used were 11.2 mm, 8.0 mm, 5.6 mm, 4.0 mm, 2.8 mm, 2.0 mm, 1.4 mm, and 1.0 mm. In a sieving apparatus (AS200, Retsch GmbH), all of the above sieves were placed from the top in descending order of opening size. and a pan was further placed at the bottom. The pulverized sample was poured from above the sieve having an opening of 11.2 mm, and the sieving test was performed for 2 minutes at an amplitude of 2 mm/g.

In addition, using the device shown in FIG. 1, the pulverized product of the sample remaining on each sieve in the sieving test was poured into the device, and a thickness separation test was carried out. The sizes of the thickness in the thickness separation test were 5.6 mm, 4.0 mm, 2.8 mm, 2.0 mm, 1.4 mm, 1.0 mm, 0.7 mm, 0.5 mm and 0.35 mm, which were half the respective opening sizes used in the sieving test.

Through the sieving test and the thickness separation test described above, the pulverized product was classified into various sizes. Among the pulverized products classified, those having a particle diameter of 5.6 mm or less and a thickness of 4 mm or less are shown in a table as follows.

TABLE 1

| | | | Thickness Z[mm] | | | | | | | |
|---|---|---|---|---|---|---|---|---|---|---|
| | | | 2.8 < | 2 < | 1.4 < | 1 < | 0.7 < | 0.5 < | 0.35 < | |
| | | Group | Z ≤ 4 | Z ≤ 2.8 | Z ≤ 2 | Z ≤ 1.4 | Z ≤ 1 | Z ≤ 0.7 | Z ≤ 0.5 | Z ≤ 0.35 |
| Particle | 4 < X ≤ 5.6 | A | A1 | A2 | A3 | A4 | A5 | A6 | A7 | A8 |
| diameter | 2.8 < X ≤ 4 | B | — | B1 | B2 | B3 | B4 | B5 | B6 | B7 |
| X | 2 < X ≤ 2.8 | C | — | — | C1 | C2 | C3 | C4 | C5 | C6 |
| [mm] | 1.4 < X ≤ 2 | D | — | — | — | D1 | D2 | D3 | D4 | D5 |
| | 1 < X ≤ 1.4 | E | — | — | — | — | E1 | E2 | E3 | E4 |
| | X ≤ 1 | — | — | — | — | — | — | — | — | — |

As described above, a pulverized product having a particle diameter larger than 4 mm and equal to or less than 5.6 mm and a thickness of 4 mm or less was taken as group A, and was further classified into groups A1 to A8 according to the thickness. A pulverized product having a particle diameter larger than 2.8 mm and equal to or less than 4 mm and a thickness of 2.8 mm or less was taken as group B, and was further classified into groups B1 to B7 according to the thickness. A pulverized product having a particle diameter larger than 2 mm and equal to or less than 2.8 mm and a thickness of 2 mm or less was taken as group C, and was further classified into groups C1 to C6 according to the thickness. A pulverized product having a particle diameter larger than 1.4 mm and equal to or less than 2 mm and a thickness of 1.4 mm or less was taken as group D, and was further classified into groups D1 to D5 according to the thickness. A pulverized product having a particle diameter larger than 1 mm and equal to or less than 1.4 mm and a thickness of 1 mm or less was taken as group E, and was further classified into groups E1 to E4 according to the thickness.

Regarding the above table, the ratio (Z/X) of the thickness (Z) to the particle diameter (X) was calculated using the intermediate value of the particle diameter range and the intermediate value of the thickness range, and the results thereof were as follows.

TABLE 2

| | | | Thickness Z[mm] | | | | | | | |
|---|---|---|---|---|---|---|---|---|---|---|
| | | | 2.8 < | 2 < | 1.4 < | 1 < | 0.7 < | 0.5 < | 0.35 < | |
| | | Group | Z ≤ 4 | Z ≤ 2.8 | Z ≤ 2 | Z ≤ 1.4 | Z ≤ 1 | Z ≤ 0.7 | Z ≤ 0.5 | Z ≤ 0.35 |
| Particle | 4 < X ≤ 5.6 | A | 0.71 | 0.50 | 0.35 | 0.25 | 0.18 | 0.13 | 0.09 | — |
| diameter | 2.8 < X ≤ 4 | B | — | 0.71 | 0.50 | 0.35 | 0.25 | 0.18 | 0.13 | — |
| X | 2 < X ≤ 2.8 | C | — | — | 0.71 | 0.50 | 0.35 | 0.25 | 0.18 | — |
| [mm] | 1.4 < X ≤ 2 | D | — | — | — | 0.71 | 0.50 | 0.35 | 0.25 | — |
| | 1 < X ≤ 1.4 | E | — | — | — | — | 0.71 | 0.50 | 0.35 | — |
| | X ≤ 1 | — | — | — | — | — | — | — | — | — |

The pulverized products of groups A to E were taken as flaky particles, and a pulverized product having a particle diameter larger than that of group A (that is, a pulverized product having a particle diameter exceeding 5.6 mm) was taken as large-grain particles. Then, additionally using a pulverized product corresponding to neither the flaky particles nor the large-grain particles, samples P to T were prepared by mixing the pulverized products in the contents shown in the following table, and each of samples P to T was accommodated in an openable glass transparent container.

Samples Q to T including flaky particles were adjusted so that the pulverized products of groups A to E were included in equal amounts. In addition, with respect to the pulverized product corresponding to neither the flaky particles nor the large-grain particles, the samples were adjusted such that a pulverized product having a particle diameter larger than 4 mm and equal to or less than 5.6 mm and a thickness larger than 4 mm, a pulverized product having a particle diameter larger than 2.8 mm and equal to or less than 4 mm and a thickness larger than 2.8 mm, a pulverized product having a particle diameter larger than 2 mm and equal to or less than 2.8 mm and a thickness larger than 2 mm, a pulverized product having a particle diameter larger than 1.4 mm and equal to or less than 2 mm and a thickness larger than 1.4 mm, and a pulverized product having a particle diameter larger than 1 mm and equal to or less than 1.4 mm and a thickness larger than 1.0 mm were included in equal amounts. While preparing samples Q to T, it was visually confirmed that the pulverized products of groups A3 to A5, B2 to B4, C2 to C6, D2 to DS, and E2 to E4 were all included in samples Q to T.

Samples P to T described above were examined for preference during consumption. Subjects were divided into two groups of nine subjects, and samples P, R, and S were tasted by one group (subject group 1) and samples Q, R, and T were tasted by the other group (subject group 2) as shown in the table above.

The test for examining preference of samples P to T was performed by measuring brain waves at INTAGE Inc. First, each subject received an explanation of the test and visually confirmed three samples in a powder state at that time. Each subject then drunk water and rested for recording of a baseline of brain waves. Thereafter, each subject visually confirmed a target sample in a powder state and then consumed a tea beverage in which 0.7 g of the sample was dissolved in 100 mL of water. After consuming the tea beverage, each subject rested again, during which the brain waves were measured. The procedures after the explanation of the test were repeated for each sample (three times in total). Alpha waves were measured as the brain waves, and alpha wave asymmetry was analyzed.

Results of the brain waves are as shown in FIG. 2, in subject group 1, the obtained result of the alpha wave asymmetry analysis revealed that sample R and sample S were perceived more favorably than sample P. In subject group 2, the obtained result revealed that sample R and sample T were perceived more favorably than sample Q.

In addition to the test described above, sensory evaluation was performed by two expert panelists, in which samples P to T were taken directly. The sensory evaluation was performed in terms of the following three items, and evaluation scores were given according to the following criteria. A sample that received two or more points for all of the three evaluation items was regarded as acceptable.

### Ease of Dissolving in Mouth

3: Dissolved smoothly
2: Dissolved slightly smoothly
1: Hardly dissolved
Coarse texture during chewing
3: Without coarse texture
2: With little coarse texture
1: With coarse texture

### Ease of Swallowing

3: Caused no choking when swallowed
2: Causes little choking when swallowed
1: Caused choking when swallowed

Matcha powder was used in addition to samples P to T as a sample to be evaluated, and 0.1 g of each sample was weighed and taken. An average value of evaluation scores given by expert panelists was taken as a final evaluation result.

The results are as shown above, and all of samples R, S, and T showed excellent evaluation results in terms of ease of dissolving in the mouth, coarse texture during chewing, and ease of swallowing.

1. A tea powder composition comprising one or more of (a) to (e) below:
(a) solid particle A having a particle diameter larger than 4 mm and equal to or less than 5.6 mm and a thickness of 4 mm or less;
(b) solid particle B having a particle diameter larger than 2.8 mm and equal to or less than 4 mm and a thickness of 2.8 mm or less;
(c) solid particle C having a particle diameter larger than 2 mm and equal to or less than 2.8 mm and a thickness of 2 mm or less;
(d) solid particle D having a particle diameter larger than 1.4 mm and equal to or less than 2 mm and a thickness of 1.4 mm or less; and
(e) solid particle E having a particle diameter larger than 1 mm and equal to or less than 1.4 mm and a thickness of 1 mm or less, wherein
a total content of solid particles A to E is 10% by weight or more, and
a content of solid particles having a particle diameter exceeding 5.6 mm is 15% by weight or less.

2. The composition according to claim 1, wherein the total content of solid particles A to E is 20% by weight or more.

3. The composition according to claim 1, wherein the content of the solid particles having a particle diameter exceeding 5.6 mm is 8% by weight or less.

4. The composition according to claim 1, wherein solid particles A to E have a shape of pulverized tea leaves.

5. The composition according to claim 1, wherein the composition is packaged in a container.

6. The composition according to claim 5, wherein the container is a transparent container.
